(19) United States
(12) Patent Application Publication
(10) Pub. No.: US 2023/0099152 A1
(43) Pub. Date: Mar. 30, 2023

(54) CONTACTLESS DATA COMMUNICATION AND ELECTRIC POWER SUPPLY DEVICE, IN PARTICULAR FOR AN AIRCRAFT

(71) Applicants: Airbus SAS, Blagnac (FR); Airbus Operations SAS, Toulouse (FR)

(72) Inventors: Frédéric GOULLEY, TOULOUSE (FR); Jean-Michel MARQUISE, TOULOUSE (FR); Cédric JURBERT, BLAGNAC (FR); Frédéric SICK, TOULOUSE (FR)

(21) Appl. No.: 17/951,171

(22) Filed: Sep. 23, 2022

(30) Foreign Application Priority Data
Sep. 29, 2021 (FR) 2110261

(51) Int. Cl. H02J 50/10; H04B 10/116; H04B 10/114; B64D 11/06

(52) U.S. Cl. CPC H02J 50/10; H04B 10/116; H04B 10/1149; B64D 11/0624; B64D 2221/00

(57) ABSTRACT

A device having at least one communication unit arranged in a wall of the aircraft and at least one communication unit arranged in a seat of the aircraft, which are able to cooperate with one another in order to communicate data by means of visible light. The device also includes at least one inductive transmitter arranged in the wall and at least one inductive receiver arranged in the seat, which are able to cooperate with one another in order to transmit electric power by induction. Also a system with such a device and an aircraft with such a device or such a system.

### CROSS-REFERENCES TO RELATED APPLICATIONS

This application claims the benefit of the French patent application No. 2110261 filed on Sep. 29, 2021, the entire disclosures of which are incorporated herein by way of reference.

### BACKGROUND OF THE INVENTION

The present invention relates to a data communication and electric power supply device, in particular for an aircraft and notably for seats of the aircraft, as well as to an aircraft provided with such a device.

### DESCRIPTION OF THE PRIOR ART

The seats of an aircraft, in particular the passenger seats of a transport plane, are generally equipped with several accessories intended for the comfort of the passengers, for communicating information or indeed for safety. In particular, the seats of a transport plane are, in general, provided with multi-purpose screens, notably for entertainment or transmitting information, and with sockets for connecting electronic devices. In addition, the consequence of the development of smart and connected seats in aircraft is to multiply the number of these accessories.

In order to operate, the majority of these accessories need to be supplied with energy and to exchange data with systems of the aircraft. For this purpose, cable harnesses are generally installed in the floor of the aircraft and the accessories of the seats are connected to these harnesses in order to be supplied with electric power and connected to a data communication network of the aircraft.

This solution is not entirely satisfactory, as it requires installation of harnesses in the floor of the aircraft, which is complex and costly. Moreover, such installation makes reconfiguration of a cabin of an aircraft, comprising modification of the position of at least some of the seats, difficult.

### SUMMARY OF THE INVENTION

An object of the present invention is to propose a solution making it possible to overcome the aforementioned drawback.

To this end, it relates to a data communication and electric power supply device, in particular for an aircraft and notably for seats of the aircraft.

According to the invention, the device comprises at least:
a first communication unit intended to be arranged in a wall of the aircraft and a second communication unit intended to be arranged in a seat, said first and second communication units being able to cooperate with one another in order to communicate data by means of visible light; and
one inductive transmitter intended to be arranged in a wall of the aircraft and one inductive receiver intended to be arranged in a seat, said transmitter and said receiver being able to cooperate with one another in order to transmit electric power by means of induction.

Thus, by virtue of the invention, a data communication and electric power supply device is obtained which is contactless, said device notably making it possible to communicate data by means of visible light and to transmit electric power by means of induction to seats of an aircraft. Such a device therefore does not require harnesses passing through the floor of the aircraft. This simplifies installation of the data communication and electric power supply device and facilitates reconfiguration of a cabin of the aircraft, comprising modification of the position of at least some of the seats, as the seats are no longer physically connected to harnesses.

Moreover, advantageously, the device comprises:
a first transmission module corresponding to a structural block and comprising the first communication unit and the inductive transmitter; and
a second transmission module corresponding to a structural block and comprising the second communication unit and the inductive receiver.

Furthermore, at least one of said first and second communication units comprises at least one micro-light-emitting diode and at least one photoreceptor.

In one particular embodiment, the device comprises at least one raceway intended to be arranged on a wall of the aircraft, and said raceway is configured to be able to accommodate a plurality of first transmission modules, each of said transmission modules notably having a size and a shape such that it may be inserted into (mounted in) the raceway.

Advantageously, the raceway comprises a plurality of connectors which are arranged along said raceway, each connector being configured so that at least one first transmission module may be connected thereto.

Moreover, the device comprises at least one cover provided with at least one translucent zone, and configured to be able to be mounted on the raceway. In a preferred embodiment, the cover is configured to be mounted on the raceway by means of clips.

In addition, the device comprises at least one protective element configured to prevent access to a space situated between the first transmission module and the second transmission module.

The present invention also relates to a data communication and electric power supply system for an aircraft.

According to the invention, the system comprises:
at least one data communication and electric power supply device;
at least one data management unit which is able to manage the data communication of the communication units; and
at least one electric power supply unit which is able to deliver electrical energy to the one or more inductive transmitters.

The present invention also relates to an aircraft, in particular a transport plane, comprising at least one data communication and electric power supply device, like the one described above, and/or at least one data communication and electric power supply system, like the one described above.

### BRIEF DESCRIPTION OF THE DRAWINGS

The appended figures will make it clearly understood how the invention may be embodied. In these figures, identical references denote similar elements.

FIG. 1 is a perspective view of a first transmission module and of a second transmission module of a data communication and electric power supply device.

FIG. 2 is a perspective view of a raceway intended to accommodate a first transmission module.

FIG. 3 is a perspective view of a cover provided with clips, which is intended to be arranged on the raceway of FIG. 2.

FIG. 4 is a perspective view of a portion of a cabin of an aircraft comprising a row of seats and a wall, provided with a data communication and electric power supply device.

FIG. 5 is an overview diagram of one particular embodiment of a data communication and electric power supply system of the aircraft.

FIG. 6 is a schematic view of an aircraft comprising a data communication and electric power supply system.

### DESCRIPTION OF THE PREFERRED EMBODIMENTS

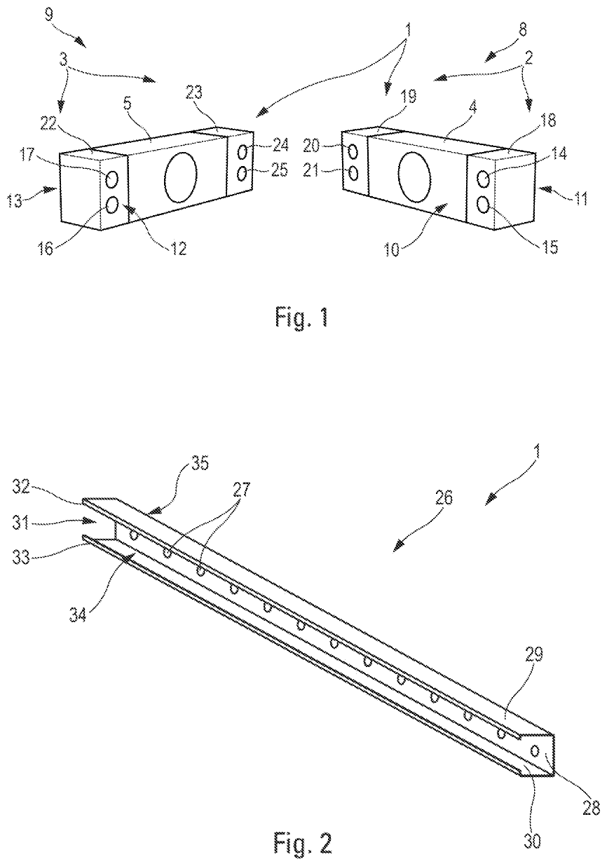

The device 1, according to the invention and one embodiment of which is schematically shown in FIG. 1, is a contactless data communication and electric power supply device. This device 1 is intended to be arranged in an aircraft in order to transmit data as well as electrical energy to items of equipment of said aircraft, notably to items of equipment which are mounted on seats, in particular on passenger seats of a transport plane. However, the device 1 may be adapted to any type of vehicle comprising items of equipment requiring electric power supply and data transmission.

For this purpose, the device 1 comprises at least:
a first communication unit 2 and a second communication unit 3 which are able to cooperate with one another in order to wirelessly communicate data via visible light; and
an inductive transmitter 4 and an inductive receiver 5 which are able to cooperate with one another in order to transmit electric power by means of induction.

In the context of the present invention, data communication via “visible light” or via “light signals” refers to all wireless communication technologies based on the use of visible light, namely at a wavelength of between 480 nm and 650 nm, also called VLC (for Visible Light Communication). Preferably, the communication units 2 and 3 communicate data via Li-Fi (Light-Fidelity) technology, which uses data coding and exchange by means of light amplitude modulation.

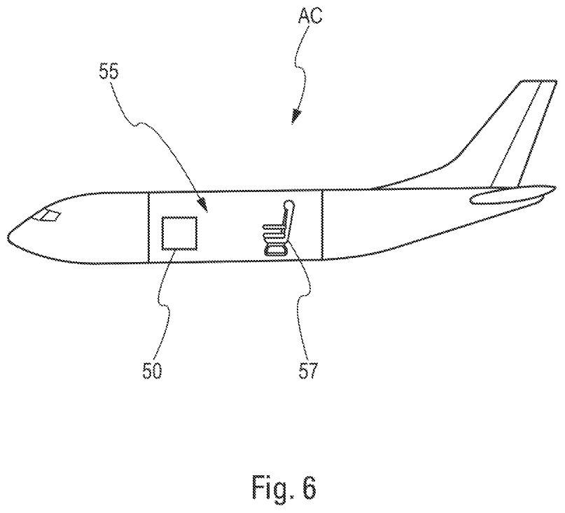

The device 1 is configured to make it possible to transmit data and electric power from a wall of the aircraft AC (FIG. 6) to at least one seat of said aircraft AC. To this end, the communication unit 2 and the inductive transmitter 4 are arranged in a wall 6 (FIG. 4) of the aircraft and the communication unit 3 and the inductive receiver 5 are arranged in a seat 7A (FIG. 4) of said aircraft.

The communication units 2 and 3 each comprise at least one transmission component and/or at least one reception component so as to be able to exchange data bidirectionally, that is to say in both directions, from the communication unit 2 to the communication unit 3 and from the communication unit 3 to the communication unit 2. Preferably, the transmission component corresponds to a micro-light-emitting diode (often abbreviated to micro-LED) which is able to be modulated at a very high frequency, and the reception component corresponds to a photoreceptor which is able to pick up the modulated signals generated by the micro-light-emitting diode. In the remainder of the description, the term “microdiode” will be used alone to refer to such a micro-light-emitting diode.

Furthermore, the inductive transmitter 4 and the inductive receiver 5 each comprise a coil, preferably a flexible coil. These coils are able to transmit electric power by means of induction from the inductive transmitter 4 to the inductive receiver 5 in an ordinary manner. The communication units 2 and 3 are arranged so as to be able to communicate data via light signals in an ordinary manner Said communication units 2 and 3 are considered to be able to communicate with one another when they are arranged face to face and at least one of the transmission components of one of the communication units is considered to face one of the reception components of the other communication unit. Preferably, the distance between the communication units 2 and 3 is of the order of a few centimeters.

Likewise, the inductive transmitter 4 and the inductive receiver 5 are arranged so that the inductive transmitter 4 may transmit electric power by means of induction to the inductive receiver 5 in an ordinary manner. To this end, the inductive transmitter 4 is arranged facing the inductive receiver 5, at a distance of a few centimeters at most.

In a preferred embodiment, shown in FIG. 1, the device 1 comprises a first transmission module 8 corresponding to a (single) structural block (that is to say to a single part). This first transmission module 8 comprises the communication unit 2 and the inductive transmitter 4. Likewise, the device 1 comprises a second transmission module 9 also corresponding to a (single) structural block (that is to say to a single part). This second transmission module 9 comprises the communication unit 3 and the inductive receiver 5.

The transmission modules 8 and 9 may, for example, correspond to housings configured to accommodate at least one communication unit 2 or 3 (which may be identical), as well as either an inductive transmitter 4 or an inductive receiver 5.

Moreover, the transmission module 8 is arranged in the wall 6 of the aircraft, as shown in FIG. 4, and the transmission module 9 is arranged in the seat 7A, which seat is located in a row closest to said wall 6. In particular, the transmission modules 8 and 9 are arranged facing one another so that both:
the communication units 2 and 3 are able to exchange data; and
the inductive transmitter 4 is able to transmit energy to the inductive receiver 5 for electric power supply.

In the particular embodiment shown in FIG. 1, the transmission modules 8 and 9 have the shape of a rectangular parallelepiped. Each of said transmission modules 8 and 9 is provided with a face referred to as the “front” face and with a face referred to as the “back” face. The transmission module 8 is provided with a front face 10 and with a back face 11, and the transmission module 9 is provided with a front face 12 and with a back face 13. The front faces 10 and 12 are the faces intended to be arranged facing one another, while the back faces 11 and 13 are the faces intended to be fastened to the wall 6 and the seat 7, respectively. The back faces 11 and 13 are notably intended to make it possible to produce the interface between the transmission modules 8 and 9 and systems of the aircraft, as explained below.

In addition, in a preferred embodiment, the wall 6 comprises an add-on element which is able to accommodate the transmission module 8. Preferably, this add-on element corresponds to a raceway as described below. However, in another embodiment (which is not shown), the transmission module 8 is fastened directly to the wall 6 by means of fastening elements, for example by means of adhesive or screws. In one variant embodiment (which is not shown), the transmission module 8 may be embedded in a recess made, for this purpose, in the wall 6.

Furthermore, in one particular embodiment (which is not shown), the transmission module 9 is fastened to the seat 7A by means of a fastening element, for example by means of adhesive or screws. In one variant embodiment (which is not shown), it may be incorporated directly into the seat 7, for example by virtue of a recess made for this purpose, in which it is mounted.

In the preferred embodiment, shown in FIG. 1, the communication unit 2 comprises a microdiode 14 and a photoreceptor 15, and the communication unit 3 comprises a microdiode 16 and a photoreceptor 17. Moreover, said communication units 2 and 3 are configured so that the microdiode 14 is able to transmit data in the form of light signals to the photoreceptor 17, which the latter is able to detect. Likewise, the microdiode 16 is able to transmit data in the form of light signals to the photoreceptor 15, which the latter is able to detect.

In one particular embodiment, the communication units 2 and 3 each comprise a plurality of microdiodes as well as a plurality of photoreceptors. Furthermore, each microdiode of a communication unit 2, 3 is able to transmit signals to at least one photoreceptor of the other communication unit. Conversely, each photoreceptor of a communication unit is able to detect signals transmitted by at least one of the microdiodes of the other communication unit.

In addition, the communication units 2 and 3 may each comprise a plurality of assemblies each comprising at least one microdiode and at least one photoreceptor.

In the embodiment shown in FIG. 1, the communication unit 2 comprises a first assembly 18 comprising the microdiode 14 and the photoreceptor 15, and a second assembly 19 comprising a microdiode 20 and a photoreceptor 21. Moreover, the communication unit 3 also comprises a first assembly 22 comprising the microdiode 16 and the photoreceptor 17, and a second assembly 23 comprising a microdiode 25 and a photoreceptor 24.

In this particular embodiment, the assemblies 18 and 22 and the assemblies 19 and 23 may be used differently.

In a first implementation, the assemblies 18 and 22 are intended for operation of the communication units 2 and 3 in a standard context, while the assemblies 19 and 23 are intended for a redundancy function. Thus, in a normal operating mode, only the assemblies 18 and 22 operate, namely exchange data, while the assemblies 19 and 23 are on standby, namely are supplied with power but do not exchange data. In a failure mode, that is to say in the event that at least one of the assemblies 18 or 22 is not operating correctly, the assemblies 19 and 23 are brought into operation. Such an implementation makes it possible to avoid a break in communications in the event of a failure of this type.

In a second implementation, the assemblies 18 and 22 and the assemblies 19 and 23 operate simultaneously. Such an implementation makes it possible to communicate a large amount of data quickly. In one particular embodiment, this implementation is used intermittently in order to optimize the data transmission speed. For example, in a normal state, only the assemblies 18 and 22 operate and, in a particular state requiring transfer of a large amount of data, the assemblies 19 and 23 are brought into operation, in parallel with the assemblies 18 and 22, in order to be able to communicate more data quickly.

Furthermore, the back faces 11 and 13 of the transmission modules 8 and 9 are provided with connectors (which are not shown). These connectors may correspond to ordinary connection elements, of male or female type, such as electric plugs or sockets. They are configured to be able to be connected to cooperating connectors which are provided for this purpose in the wall 6 and the seat 7A so as to make it possible to transmit data and electric power. Moreover, each module 8 and 9 may comprise a single connector combining the functions of transmitting data and electrical energy or several distinct connectors, notably a connector for transmitting data and a connector for transmitting electrical energy.

In addition, in one particular embodiment, the device 1 comprises a raceway 26 shown in FIG. 2, which is arranged on the wall 6 of the aircraft, as explained below. This raceway 26 is configured to be able to accommodate a plurality of transmission modules 8. To this end, each of the transmission modules 8 notably has a size and a shape such that it may be inserted into (mounted in) the raceway 26. The raceway 26 may be an element added on and fastened to a surface of the wall 6 or an element arranged in a recess made for this purpose, for example by being screwed or adhesively bonded therein. Moreover, the raceway 26 is provided with holes 27, for example round ones, which are configured to allow access to the connectors of the wall 6 so that the connectors of the transmission modules 8 may be connected thereto. This raceway 26 may be produced from various materials, and preferably from plastic.

In a preferred embodiment of this particular embodiment, shown in FIG. 2, the raceway 26 corresponds to a rectilinear elongated element having a profile, namely a cross section, in the shape of a square “U” (that is to say, the bottom of which is not curved but straight), which is open at its longitudinal ends. In particular, the raceway 26 comprises a bottom 28, lateral sides 29 and 30 and an open face 31. The open face 31 comprises two edges 32 and 33 corresponding to orthogonal continuations of the lateral sides 29 and 30, said edges 32 and 33 forming an opening 34 between them. The opening 34 has a rectangular shape extending over the whole length of the raceway 26 and it opens out at the longitudinal ends of said raceway 26.

The bottom 28 of the raceway 26 has an outer face 35 (namely oriented toward the outside of the “U” shape) which may comprise fastening elements in order to fasten said bottom 28 to the wall 6, for example by means of screwing or adhesive bonding. The bottom 28 also comprises the holes 27, which are through holes making it possible to connect the transmission modules 8 to the connectors (which are not shown) of the wall 6.

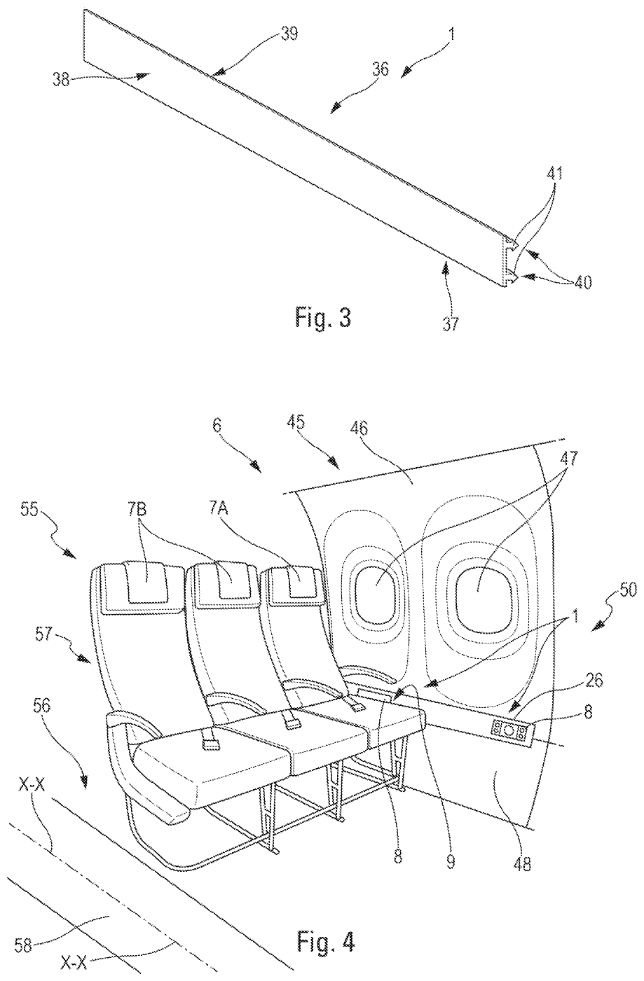

Furthermore, the device 1 comprises at least one cover 36 (FIG. 3) intended to be arranged on the raceway 26 (FIG. 2). The cover 36 is provided with at least one translucent zone which is able to let the light signals transmitted by the communication units 2 and 3 pass through so that said communication units 2 and 3 may exchange data via these light signals. As a variant, the cover 36 may also be transparent, at least in part.

In a preferred embodiment, illustrated in FIG. 3, the cover 36 is intended to be arranged on the raceway 26 by means of clips 40. The cover 36 corresponds to an elongated plate 37, preferably of low thickness (of the order of one millimeter), of the same length as the raceway 26 and provided, on one of its faces, with a flat surface 38 and, on its opposite face, with a surface 39 provided with two clips 40. The surface 38 is intended to be oriented toward the outside of the raceway 26 while the surface 39 is intended to be oriented toward the inside of the raceway 26, the cover 36 being fastened to the raceway 26 by means of the clips 40.

In the embodiment shown in FIG. 3, the clips 40 correspond to two shapes extruded over the whole length of the cover 36. These shapes are substantially orthogonal to the plate 37 of the cover 36. Moreover, the clips 40 are provided, at their free ends, with hook shapes 41 which are able to cooperate elastically with the edges 32 and 33 of the open face 31 of the raceway 26 so as to be able to easily mount and dismount the cover 36.

In another embodiment, the cover 36 may be fastened to the raceway 26 differently, for example by being slid onto a rail (which is not shown) arranged along said raceway 26.

Furthermore, in one particular embodiment (which is not shown), the device 1 may comprise a plurality of covers 36. In particular, it may comprise shorter covers 36 distributed over the whole length of the raceway 26, each of these covers 36 being individually dismountable.

Furthermore, at least the plate 37 of the cover 36 is produced from a translucent material, for example a thermoplastic polymer, which is able to make it possible to transmit light signals, notably between the communication modules 8 and 9. However, the cover 36 may also comprise an opaque plate 37 provided with a plurality of translucent (or transparent) zones, which are made where the transmission modules 8 and 9 are arranged.

Moreover, in one particular embodiment, at least part of the surface 38 of the cover 36, intended to be oriented toward the outside, may comprise information, for example inscriptions or decorations in the form of adhesively bonded, drawn or etched messages.

In one particular embodiment, the device 1 may comprise another cover (which is not shown) intended to be arranged on the seat 7A near the transmission module 9 and having, for example, features similar to those of the cover 36.

In addition, in one preferred embodiment, the device 1 comprises a protective element (which is not shown) intended to prevent access to the space situated between the transmission modules 8 and 9 and thus avoid transmission of the signals being disturbed or prevented. The protective element is intended to be arranged between the wall 6 and the seat 7A and preferably has a narrow and elongated shape so as to be able to be wedged between the wall 6 and the seat 7A, and to cover all or part of the length of the raceway 26.

Preferably, the protective element is fastened so as to be able to be removed by means of ordinary fastening means. Non-limitingly, the protective element may correspond to a rigid shelf, for example made from plastic, or a flexible sheath, for example made from rubber.

In one particular embodiment, the protective element corresponds to a continuation of at least one of the lateral sides 29 and 30 of the raceway 26 (FIG. 2). This continuation extends from the raceway 26 to the seat 7A and therefore makes it possible to prevent access to the space situated between the transmission modules 8 and 9. The protective element may also be fastened to the seat 7A.

In one particular embodiment, shown in FIG. 4, the wall 6 of the aircraft is composed of a plurality of wall sections which are joined together. Each of these wall sections corresponds to a panel 45 which is able to be juxtaposed and joined to other similar panels in order to form the wall 6.

In this embodiment, the panel 45 comprises an upper portion 46, provided with windows 47, and a lower portion 48. Moreover, the raceway 26 has the same length as the panel 45 and it is arranged at the interface between the upper portion 46 and the lower portion 48 of said panel 45.

Furthermore, the raceway 26 is configured so that, when the panels are joined in order to form the wall 6, it is aligned with the raceways of the adjacent panels.

The device 1 as described above forms part of a data communication and electric power supply system 50 intended to be incorporated into an aircraft AC (FIG. 6), and which comprises at least one such device 1.

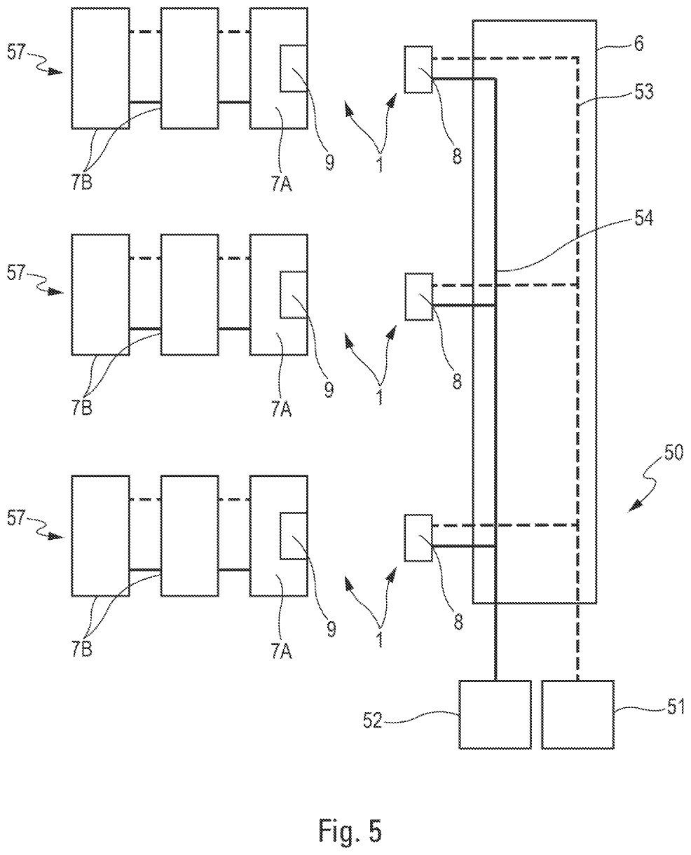

In the particular embodiment schematically shown in FIG. 5, the system 50 comprises a plurality of devices 1, as well as a data management unit 51 and an electric power supply unit 52. The data management unit 51 is configured to manage the data communication of the communication units 2 and 3 of the devices 1, and the electric power supply unit 52 is configured to deliver electrical energy to the inductive transmitters 4 of the devices 1.

The system 50 comprises connections 53 which are arranged in the wall 6 and make it possible for the data management unit 51 to be connected to the communication units 2 via the connectors (which are not shown) of the wall 6. The connections 53 correspond to ordinary data communication cables, for example Ethernet or optical cables.

The system 50 also comprises connections 54 which are arranged in the wall 6 and make it possible for the electric power supply unit 52 to be connected to the inductive transmitters 4 via the connectors (which are not shown) of the wall 6. The connections 54 correspond to ordinary electric power supply cables.

In a preferred embodiment, shown in FIGS. 4 and 5, the system 50 is intended to be fitted in a cabin 55 of an aircraft, part of which is shown in FIG. 4, in order to communicate data to the seats of said cabin 55 and deliver electrical energy to them. The cabin 55 corresponds to at least part of the interior of the aircraft, preferably a part intended to accommodate passengers, and it notably comprises a floor 56, at least one wall 6 and at least one row of seats 57 comprising a seat 7A arranged along the wall 6 and at least one other seat referred to as an auxiliary seat 7B.

Preferably, the cabin 55 has the following configuration:
it has a longitudinal axis direction X-X;
it comprises a rectilinear aisle 58 arranged in the center of the cabin 55, along the longitudinal axis X-X;
it comprises a plurality of rows of seats 57 which are orthogonal to the axis X-X and arranged parallel to one another, in two columns on either side of the central aisle 58;
it comprises two walls 6, delimiting the lateral sides, namely on either side of the axis X-X of the cabin 55, and against which the rows of seats 57 are arranged, the seat 7A of each row of seats 57 being the seat adjoining one of the two walls 6; and
it comprises the system 50 comprising the devices 1 such as the one described above.

Moreover, in this embodiment, the row of seats 57 comprises two auxiliary seats 7B and one seat 7A. These seats 7A and 7B are connected to one another in an ordinary manner in order to form the row of seats 57 and, more particularly, they have ordinary connections between them making it possible to communicate data and supply electric power between each of the seats 7A and 7B of the row of seats 57. This data is communicated and this electric power is supplied from the seat closest to the wall 6, namely the seat 7A, which is the seat intended to comprise the transmission module 9, to the seats 7B. In relation to data communication between the seats 7A and 7B, it is bidirectional.

The system 50, as described above, has great flexibility with regard to its installation and that of the rows of seats.

Moreover, the system 50 is particularly adapted to a reconfiguration of the cabin 55 comprising modification of the positioning of at least one row of seats 57. Indeed, the devices 1 of the system 50 make it possible to communicate data and to transmit electrical energy between the walls 6 and the rows of seats 57 contactlessly, namely without a physical connection between them. Moreover, the transmission modules 8, arranged in the walls 6, may be moved in order to be positioned in desired positions along said walls 6. Consequently, it is possible to move rows of seats 57 along the longitudinal direction X-X of the cabin 55, one way or the other, and to easily adapt the position of the associated transmission modules 8 to the new positions of the rows of seats 57.

The data communication and electric power supply system 50, as described above, also has numerous advantages. In particular:
it makes it possible to produce a floor without harnesses for communicating data and supplying electric power to the seats;
it makes very flexible installation of the rows of seats possible;
it makes it possible to reconfigure the cabin easily and with more flexibility;
it makes it possible to benefit from data transmission which is at once fast, secure and does not interfere with other wireless systems (Wi-Fi, Bluetooth, etc.); and
it avoids dependence on other types of waves such as Wi-Fi waves.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A data communication and electric power supply device for an aircraft the device comprising:
a first communication unit configured to be arranged in a wall of the aircraft and a second communication unit configured to be arranged in a seat, said first and second communication units configured to cooperate with one another in order to communicate data by means of visible light; and
an inductive transmitter configured to be arranged in a wall of the aircraft and an inductive receiver configured to be arranged in a seat, said inductive transmitter and said inductive receiver configured to cooperate with one another in order to transmit electric power by means of induction.

2. The device as claimed in claim 1, wherein at least one of said first and second communication units comprises at least one micro-light-emitting diode and at least one photoreceptor.

3. The device as claimed in claim 1 further comprising:
a first transmission module corresponding to a structural block and comprising the first communication unit and the inductive transmitter; and
a second transmission module corresponding to a structural block and comprising the second communication unit and the inductive receiver.

4. The device as claimed in claim 3, further comprising:
at least one raceway configured to be arranged on a wall of the aircraft, and
wherein said raceway is configured to accommodate a plurality of first transmission modules.

5. The device as claimed in claim 4, wherein the raceway comprises a plurality of connectors which are arranged along said raceway, each connector being configured so that at least one first transmission module is connected thereto.

6. The device as claimed in claim 4, further comprising:
at least one cover provided with at least one translucent zone, and
the at least one cover configured to be mounted on the raceway.

7. The device as claimed in claim 6, wherein the cover is configured to be mounted on the raceway by one or more clips.

8. The device as claimed in claim 3, further comprising:
a protective element configured to prevent access to a space situated between the first transmission module and the second transmission module.

9. A data communication and electric power supply system for an aircraft, the system comprising:
at least one device comprising
a first communication unit configured to be arranged in a wall of the aircraft and a second communication unit configured to be arranged in a seat, said first and second communication units configured to cooperate with one another in order to communicate data by means of visible light, and
an inductive transmitter configured to be arranged in a wall of the aircraft and an inductive receiver configured to be arranged in a seat, said inductive transmitter and said inductive receiver configured to cooperate with one another in order to transmit electric power by means of induction;
at least one data management unit configured to manage data communication of the first and second communication units; and
at least one electric power supply unit configured to deliver electrical energy to the inductive transmitter.

10. An aircraft comprising:
at least one device comprising
a first communication unit configured to be arranged in a wall of the aircraft and a second communication unit configured to be arranged in a seat, said first and second communication units configured to cooperate with one another in order to communicate data by means of visible light, and
an inductive transmitter configured to be arranged in a wall of the aircraft and an inductive receiver configured to be arranged in a seat, said inductive transmitter and said inductive receiver configured to cooperate with one another in order to transmit electric power by means of induction; and
at least one electric power supply unit configured to deliver electrical energy to the inductive transmitter.

11. The aircraft of claim 10 further comprising:
at least one data management unit configured to manage data communication of the first and second communication units.
